(19) United States
(12) Patent Application Publication
(10) Pub. No.: US 2008/0027797 A1
(43) Pub. Date: Jan. 31, 2008

(54) MANAGEMENT OF PACKAGE OFFERINGS BY LOYALTY PROGRAMS AND AUTOMATION OF ACCRUAL RECALCULATION

(75) Inventors: Yogendra JOSHI, Hyderabad (IN); Shyam SHAH, Hyderabad (IN); Rilabrata BHATTACHARYYA, Kolkala (IN); Varun AJWANI, Kola (IN); Neeta CHILUMULA, Hyderabad (IN); Sreenivasa HOSAMANE, Hyderabad (IN); Murali SUBRAMANIAN, Hyderabad (IN); Siju NARAYAN, Hyderabad (IN)

Correspondence Address: EVERGREEN VALLEY LAW GROUP, P.C. AND;ORACLE INTERNATIONAL CORPORATION, 2670 SOUTH WHITE ROAD, SUITE 275, SAN JOSE, CA, 95148, US

(73) Assignee: ORACLE INTERNATIONAL CORPORATION, RED SHORES, CA (US)

(21) Appl. No.: 11/463,879

(22) Filed: Aug. 10, 2006

(30) Foreign Application Priority Data
Jul. 31, 2006 (IN) 1343/CHE/2006

(51) Int. Cl. G06Q 30/00

(52) U.S. Cl. 705/14

(57) ABSTRACT

The present invention discloses a method and system for processing accrual and redemption package offerings in loyalty programs. The method includes identifying a set of accrual package offerings, identifying a plurality of loyalty members satisfying a set of package conditions, calculating accruals for each of the plurality of loyalty members and crediting the loyalty member accounts, and identifying a set of loyalty partners and debiting loyalty partner accounts. The method and system of the present invention enables loyalty programs to fully automate the process of setting up and managing accruals and redemption packages. The present invention also discloses a method and system of recalculating the accrual transactions. The method includes receiving a set of loyalty member activities from a plurality of loyalty partners, processing the loyalty member activities in a sequential manner according to a date of the activities, checking a necessity for recalculating the accruals; and recalculating the accruals for the loyalty member activities.

### BACKGROUND OF THE INVENTION

1. Field of the Invention

The present invention generally relates to a customer loyalty program and, in particular, to a method and system for processing package offerings in loyalty programs.

2. Description of Related Art

Customer loyalty programs were introduced by airlines, hotels, and rental car companies to retain their existing customers as well as to attract new customers. In many of these programs, a customer earns Loyalty units (generally regarded as Points, Miles, etc) for undertaking some activity (E.g. taking flights on host airline or a partner airline or a card partner). The loyalty units, which are earned in these programs, can be redeemed for various goods and services offered as awards. The principle of a loyalty program is to retain an existing customer base, as it is more expensive to bring in new customers than to retain existing ones.

Customer loyalty programs are central to airline relationships and marketing strategy, aimed at rewarding loyal customers through a plethora of innovative accrual and redemption choices. These programs have evolved over a period of time with more and more airlines crafting intelligent loyalty management programs to satisfy the demanding customer base and to cope with the increased competition. Simple accrual and redemption opportunities offered by the loyalty programs traditionally have ceased to impart effective differentiation to the airlines. An evolution in this regard has been the “packaging” of the multiple accrual and redemption offerings into a single ‘package offering’. This serves as a compelling incentive by way of bonus accruals and discounted redemption prices for the loyalty program members. For airlines, it ensures a larger share of the customer wallet, higher program revenue, enhanced customer satisfaction and larger involvement of the partners.

For example, a simple accrual options may dictate that for every Sydney-Las Vegas SYD-LAS sector flown and every 200 dollars spent staying at the Hilton, Los Angeles (LA), a loyal customer would earn 5000 and 1000 points respectively. To increase the chances of a loyal customer undertaking both the activities, the loyalty operations of an airline might choose to “package” both these choices together and as an incentive give away an additional 500 points to the member undertaking both the activities within a specified period. In such a scenario, subject to laid out conditions, a loyal customer, on flying the SYD-LAS sector and staying at the Hilton, LA for a specified period, would earn 6500 points instead of 6000 points he/she would have earned in the absence of the packaging. This is a huge incentive to boost up the member's points balance resulting in better and faster redemption opportunities.

Though airlines today do offer accrual and redemption package offerings, they are constrained by their current application in not being able to setup, process and analyze such package offerings systemically. This results in delayed and often incorrect processing of accruals and redemptions for the packages. Further, airlines lack an ability to analyze the effectiveness of their package offerings in terms of timing, composition and targeting due to lack of related systemic data. Today, there is no systemic way of setting up and operating the concept of package offerings. All processes are manual, which are fraught with errors and significantly increases time-to-market. This not only results in customer dissatisfaction but also blunts an airline's competitive edge.

Another problem arises due to plurality of partners, which are spread across geographically and also diverse in the activities offered and at different system maturity levels. This causes member accruals being reported to the loyalty program at varied time frames and not necessarily in the chronological sequence as they actually were undertaken. Loyalty programs allow loyalty members to earn loyalty units (Frequent Flyer Program (FFP)/Miles etc) as a reward for undertaking various business activities with the sponsor airlines or the loyalty partners. The loyalty units so earned by the loyalty members form the primary basis to ascertain their status (generally regarded as tier) in the loyalty program (generally there is a set hierarchy of these statuses such as bronze, silver, gold and platinum in increasing order of priority and privileges). The status of the loyalty member also determines the benefits/privileges and rewards in terms of status bonus that they are eligible for.

To substantiate the above point, take into account an example where a member in “silver” tier undertakes two activities, a flight with Vision Air on 1 Jan. 2005 and a car rental with Hertz on 15 Feb. 2005. The activity with Hertz car rental is reported first on 20 Feb. 2005 to the loyalty program, fetches the member 2000 FFP and the activity with Vision Air is reported later on 27 Feb. 2005, fetches the member 10000 FFP and 400 SC and with this the loyalty member moves to “gold” status on 1 Jan. 2005. These transactions also results into receivables of $20 from Hertz and $150 from Vision Air. If the activities were reported in the order in which they were undertaken, i.e. had the activity undertaken with Vision Air reported first, before 20 Feb. 2005, the member would have moved to “gold” status before 20 Feb. 2005 and this would have enabled the loyalty member to earn additional 500 FFP Status bonus for ‘gold’ besides the 2000 FFP, for the car rental activity with Hertz. Now this transaction would result into receivables of $150 from Vision Air and $25 from Hertz (increment of $5 with regard to the status bonus).

However, it is almost impossible for a loyalty program to ensure that the business activities undertaken by the member with various loyalty partners are received (and hence processed) in the order in which they occurred. Traditionally frequency of loyalty partners reporting member activities is driven by their system readiness, the quantum of transactions and the partnership agreement with the loyalty program. This results in member activities being reported asynchronously and hence processed out of sequence. Also there are occurrences where a loyalty member activity never gets communicated by the loyalty partners to the loyalty program and is reported by the member by way of an ‘accrual dispute’. On the partner front, this leads to incorrect billing to the loyalty partners often leading to loss of precious revenue for the loyalty program, and incorrect processing of loyalty offerings to the loyalty members.

Considering the aforementioned disadvantages, it would be advantageous to have in place a system that would allow loyalty programs to setup and process package offerings. Hence it is an object of the present invention to provide a mechanism to process the package offerings. Also, it is another object of the present invention to provide an accurate accrual recalculation processing to ensure that the loyalty member “status” is recognized as on the date of activity and loyalty member is rewarded correctly for future activities.

### SUMMARY OF THE INVENTION

In an embodiment of the present invention, a method for processing accrual package offerings in a loyalty program is provided. The method includes the steps of identifying a set of the package offerings in a loyalty program system, identifying a plurality of loyalty members satisfying a set of package conditions for availing the package bonus, calculating bonus accruals for each of the plurality of loyalty members for the package offerings and crediting the loyalty members with loyalty units, and identifying the loyalty partners for the package offerings and debiting the appropriate loyalty partner accounts. The method also includes the steps of initiating a financial entry for liability to a general ledger for the member credit and loyalty partner account debit, and updating a package accrual information and creating package transaction history in the loyalty program system.

In another embodiment of the present invention, a method for processing redemption package offerings in a loyalty program is provided. The package offerings include a set of redemption package, which include products offered by a set of loyalty partners. The method includes the steps of receiving a redemption request form a set of loyalty members, identifying the redemption packages and validating the redemption request, pricing a set of products and/or services in the redemption packages, generating a set of independent redemption vouchers for the products and/or service in the redemption packages upon receiving the payment from the loyalty members (in loyalty units or money or both), and issuing the set of redemption vouchers to the corresponding loyalty partners. The step of generating redemption vouchers further includes receiving the payment from the loyalty members and initiating a financial entry to a general ledger in the loyalty program system for points debited from member accounts, checking a number of products and/or services in the redemption packages, identifying a redemption voucher type setup, and checking a set of outbound communication rules for issuing the redemption vouchers to the corresponding recipient(s).

In another embodiment of the present invention, a system for processing package offerings in a loyalty program is provided. The system includes a partner setup module for creating a plurality of loyalty partners as an entity and associating a set of product and/or services offered by the loyalty partners, an accrual package setup module for identifying a set of the package offerings in a loyalty program system, an accrual rules setup module for identifying a plurality of loyalty members and loyalty partners for the package offerings, a pricing module for calculating accruals for each of the plurality of loyalty members for the package offerings and crediting the loyalty members with loyalty units, and a partner account debit module for debiting each loyalty partner accounts. The system further includes a transaction module for initiating a financial entry for liability to a general ledger for the loyalty partner account debit, and a transaction history module for updating a package accrual information and creating a package transaction history in the loyalty program system.

In another embodiment of the present invention, a system for processing package offerings in a loyalty program is provided. The system includes a partner setup module for creating a plurality of loyalty partners as an entity and associating a set of product and/or services offered by the loyalty partners, a redemption package setup module for identifying the redemption packages and setting up a set of agreement terms between loyalty partners and loyalty program, a pricing module for pricing a set of products and/or services in the redemption packages, and a redemption voucher generation module for generating a set of independent redemption vouchers for the products and/or service in the redemption packages upon receiving the payment from the loyalty members. An outbound communication module issues the set of redemption vouchers to the respective recipient(s).

In another embodiment of the present invention, a method for recalculating accruals in a loyalty program is provided. The method includes the steps of receiving a set of loyalty member activities from a plurality of loyalty partners, processing the loyalty member activities in a sequential manner according to a date of the activities, checking a necessity for recalculating the accruals; and recalculating the accruals for the loyalty member activities. Checking a necessity for recalculating the accruals further includes the steps of verifying a change in a qualifying loyalty account balance in loyalty member accounts, identifying a current accrual transaction for which accrual recalculation is required, and verifying one or more loyalty member activities occurred after the current accrual transaction. Recalculating the accruals further includes the steps of performing a tier assessment according to the date of activity focusing on the current accrual transaction, performing an accrual reversal for accrual activities following the current accrual transaction in a chronological order, and reprocessing the accrual activities reversed in the reversal step and performing tier assessment according to the reprocessed accrual activities.

In another embodiment of the present invention, an accrual recalculation engine is provided. The accrual recalculation engine includes a partner setup module for creating a plurality of loyalty partners as an entity and for receiving a set of loyalty member activities from the plurality of loyalty partners; a processing module for checking a necessity for recalculating the accruals and for processing the loyalty member activities according to a date of the activities, a tier assessment module for performing a tier assessment for the loyalty member activities according to the date of activities focusing on a current accrual transaction for which accrual recalculation is required. The accrual recalculation engine further includes an accrual reversal module for performing an accrual reversal for accrual activities following the current accrual transaction in a chronological order, and an accrual reprocessing module for reprocessing the accrual activities reversed in the accrual reversal module and performing tier assessment according to the reprocessed accrual activities.

The above summary of the present invention is not intended to describe each disclosed embodiment of the present invention. The figures and detailed description that follow provide additional aspects of the present invention.

### BRIEF DESCRIPTION OF DRAWINGS

The invention may be more completely understood in consideration of the following detailed description of various embodiments of the invention in connection with the accompanying drawings, in which:

FIG. 1 is a flow diagram illustrating an embodiment of the method for package accrual processing in loyalty programs.

FIG. 2 is a block diagram illustrating the components of a system for package accrual processing.

FIGS. 3a and 3b are flow diagrams illustrating an embodiment of the method for package redemption processing in loyalty programs. FIGS. 4a and 4b are flow diagrams illustrating redemption voucher generation in package redemption processing.

FIG. 5 is a block diagram illustrating the components of a system for package redemption processing.

FIG. 6 is a flow diagram illustrating an embodiment of the method for accruals recalculation in loyalty programs.

FIG. 7 is a block diagram illustrating the components of an accrual recalculation engine according to an embodiment of the present invention.

### DETAILED DESCRIPTION OF DRAWINGS

In the following description, numerous specific details are set forth in order to provide a more thorough understanding of the present invention. However, it will be apparent to one skilled in the art that the present invention may be practiced without these specific details. In other instances, well-known features have not been described in detail in order to avoid obscuring the present invention.

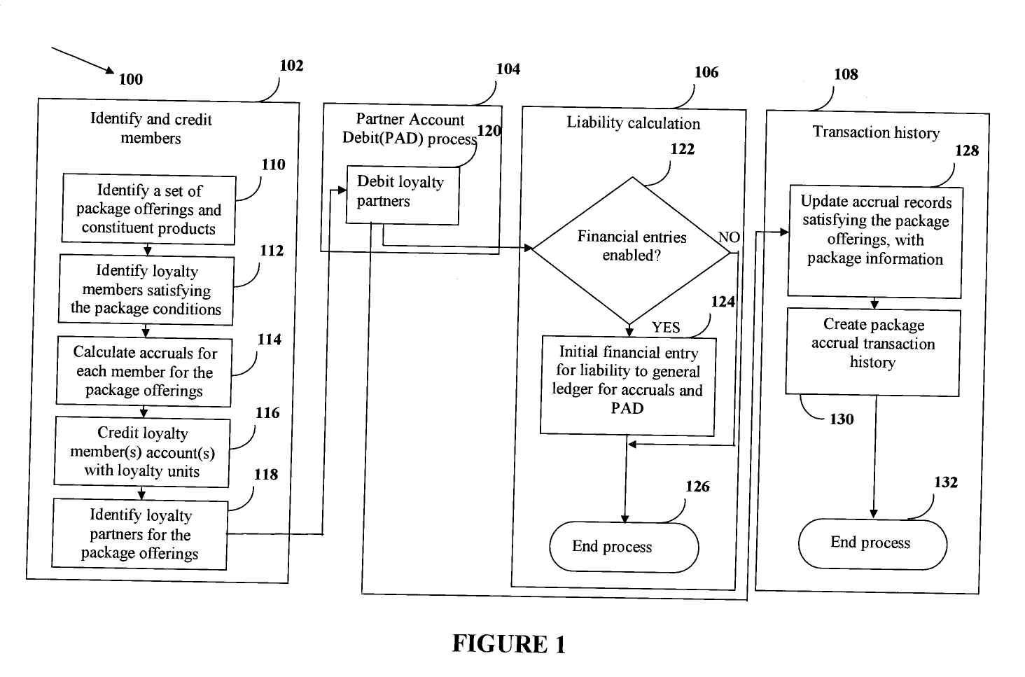

FIG. 1 is a flow diagram illustrating an embodiment of the method for package accrual processing in loyalty programs 100. Package accrual processing 100 includes an identification process 102, a partner account debit process (PAD) 104, a PAD liability calculation process 106 and a transaction history process 108. The identification process 102 identifies a set of package offerings and its constituent products and/or services in a step 110. A step 112 identifies a set of loyalty members satisfying a set of package conditions for availing the package offerings. A step 114 calculates accruals for each of the loyalty members. Then a step 116 credits the loyalty units to the loyalty member account(s). After crediting the loyalty member account(s), a step 118 identifies the loyalty partners for the package offerings.

A step 120, in the PAD process 104, calculates the loyalty units to be debited from the loyalty partner's accounts. The liability calculation process checks if financial entries are enabled in a step 122 and, if so, a step 124 initiates the financial entry for liability to a general ledger for member accruals and PAD. After initiating the financial entries, the liability calculation process ends with a step 126. The transaction history process 108 updates accrual records satisfying the package offerings, with package information in a step 128 and creates a package accrual transaction history in another step 130. Upon creating the package accrual transaction history, the transaction history process 108 ends with an end process step 132. This package accrual processing enables the loyalty program to fully automate the process of setting up and managing accruals and redemption packages.

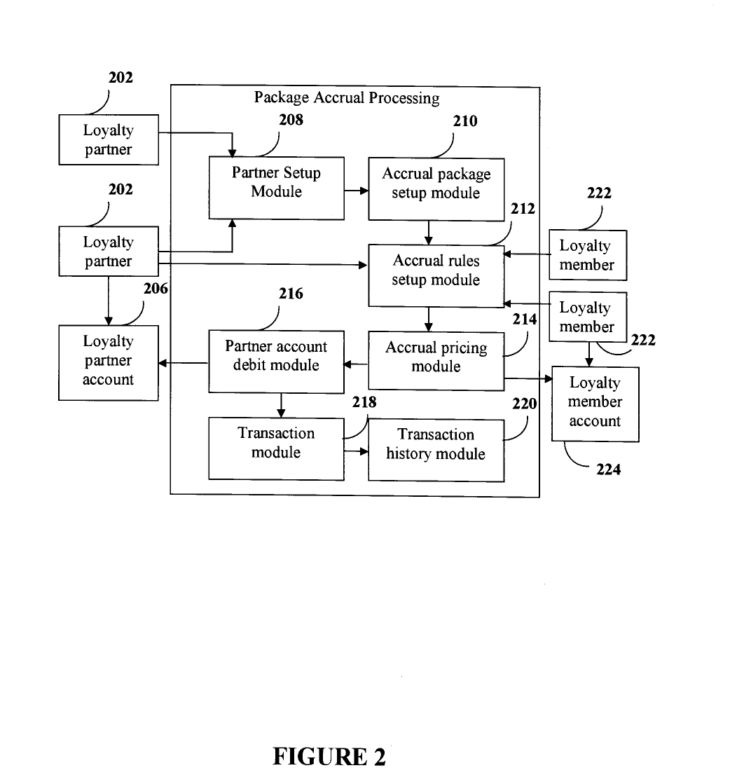

FIG. 2 is a block diagram illustrating the components of a system for package accrual processing. The package accrual processing system includes a partner setup module 208, an accrual package setup module 210, an accrual rules setup module 212, a pricing module 214, a partner account debit module 216, a transaction module 218 and a transaction history module 220. The partner setup module 208 is provided for creating a plurality of loyalty partners 202 as an entity, and also, for associating a set of product and/or services offered as package offerings by the loyalty partners 202. The accrual rules setup module 212 identifies the loyalty members 222 eligible for the package offerings. After identifying the loyalty members 222, the pricing module 214 calculates the accruals for each of the loyalty members for the package offerings and credits the loyalty member account(s) 224 with loyalty units. The partner account debit module 216 calculates the loyalty units to debit from the respective loyalty partner accounts 206. After the PAD process, the transaction module 218 initiates a financial entry to the general ledger for the loyalty program partner account debit. The transaction history module 220 updates package accrual information and also creates a package transaction history in the loyalty program system.

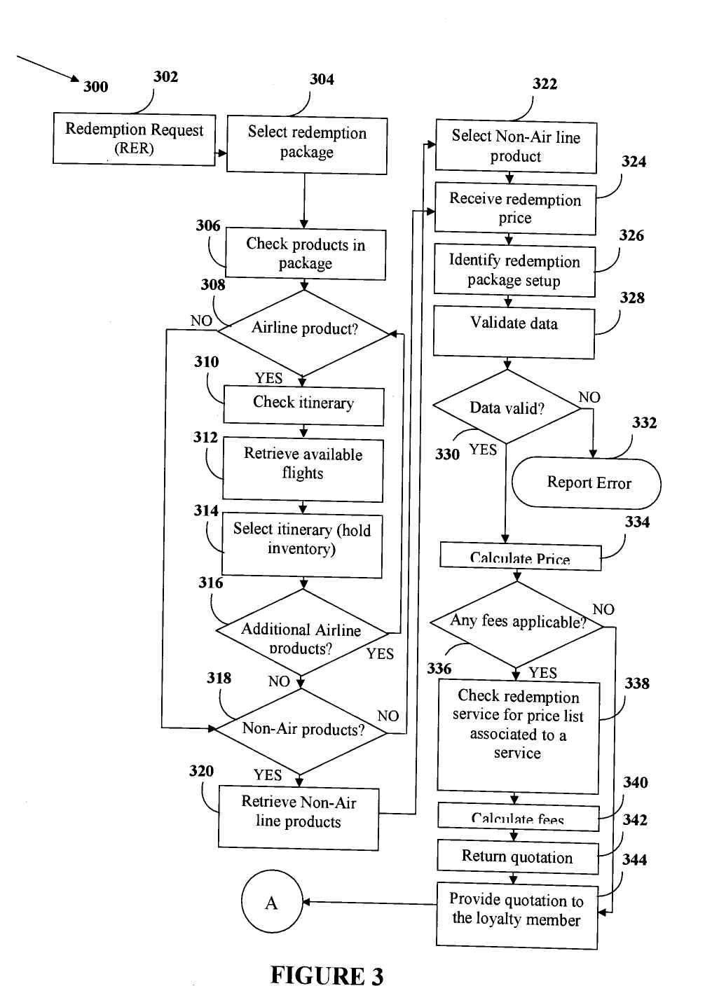

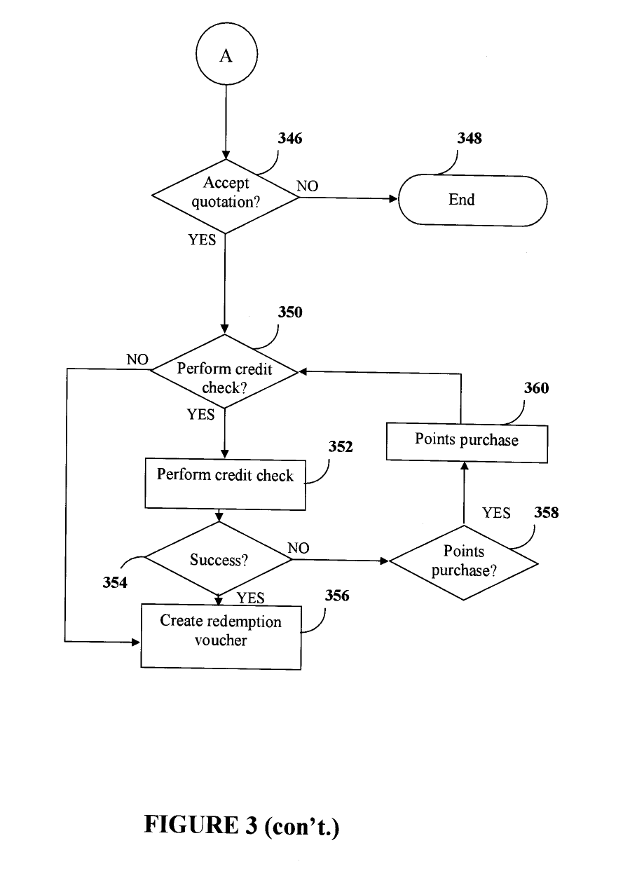

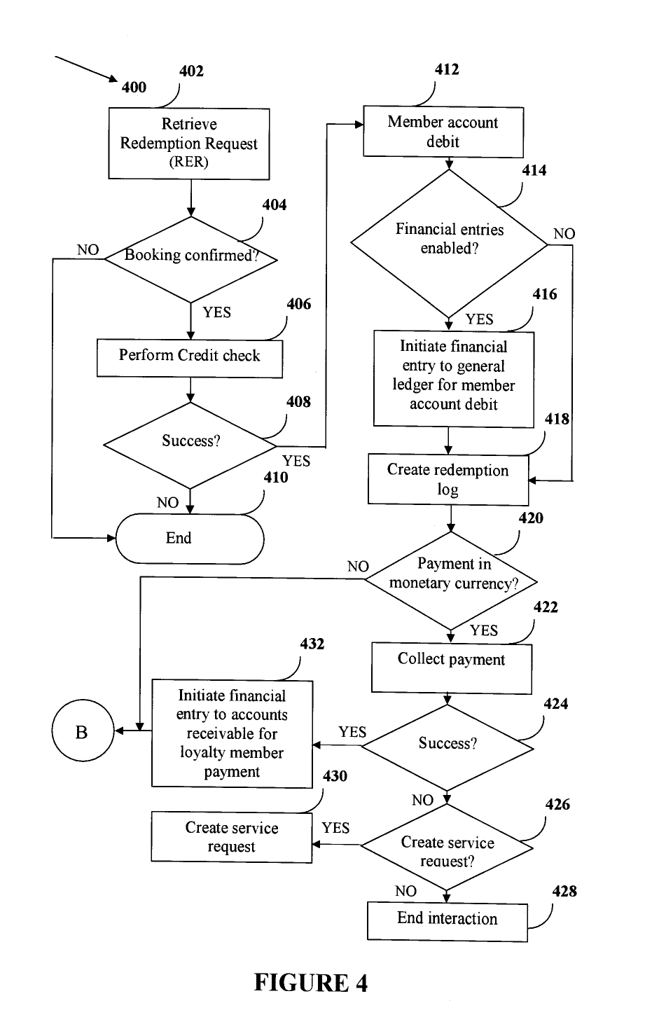

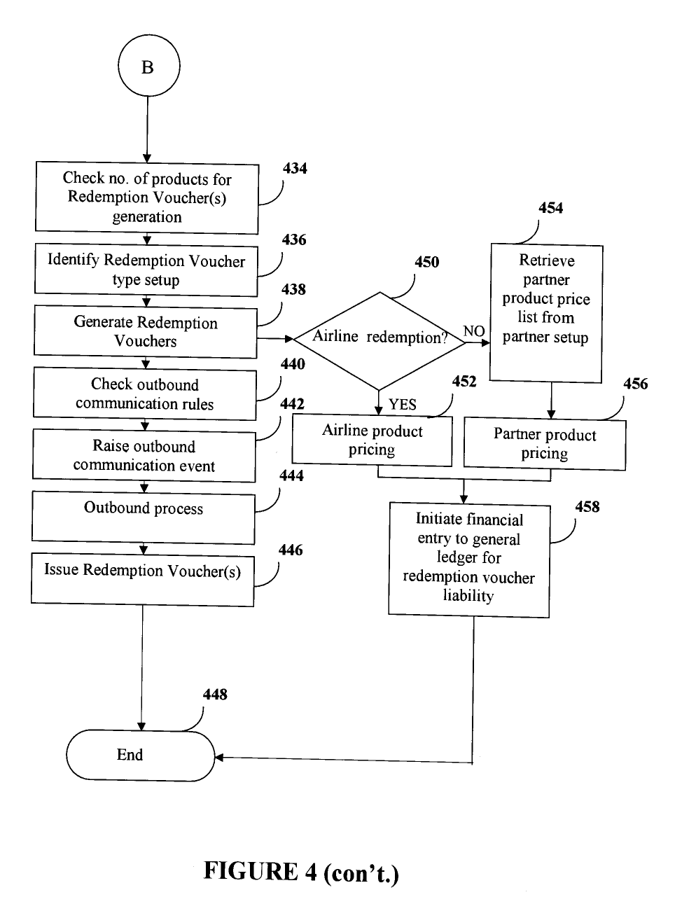

FIGS. 3a and 3b are flow diagrams illustrating an embodiment of the method for package redemption processing in loyalty programs 300. Redemption package are promotional offerings by which a loyalty program offers a package of two or more products for member consumption within a limited time period, availing which the loyalty member pays a discounted price in comparison with the price he/she would have otherwise paid for availing standalone products and/or services.

The package redemption processing 300 receives a redemption request from the loyalty members in a step 302. The loyalty member can log in to a website provided by the loyalty program and select the redemption package 304. The website checks the products in the redemption package in a step 306. A step 308 checks whether the redemption package includes airline products and, if so, another step 310 checks the itinerary and retrieves the available flights 312. The loyalty member then selects the itinerary and holds inventory in a step 314. The system checks for any additional airline products in step 316 and, if so, repeats the aforementioned process (308-314). The system then checks for non-airline products in the redemption package in step 318. If the redemption package includes non-airline products, a step 320 retrieves the non-airline products and another step 322 selects the non-airline products. After identifying all the products, the loyalty program system receives the redemption prices in a step 324 and identifies the redemption package setup in another step 326. The loyalty program system validates the data provided by the loyalty members in a step 328. If the data is not valid 330, a step 332 reports error. If the data is valid, loyalty program system calculates the price for the products and/or services selected by the loyalty member in a step 334.

Step 336 checks whether there are any additional fees applicable. If so, a step 338 checks redemption service for price list associated to the service. An agent assisted booking for an airline is an example for the case where additional fees are applicable. A step 340 calculates the additional fees and returns a quote 342. The website provides the quotation to the loyalty members in a step 344. If the loyalty member does not accept the quotation 346, the process ends in a step 348. On the other hand, if the loyalty member accepts the quotation, a step 350 checks if a credit check is needed. If the credit check is needed a step 352 performs a credit check to ascertain sufficient point balance and creates a redemption voucher 356 if the credit check is successful 354. If the credit check is not successful, a step 358 checks for purchasing points. If there is a need for purchasing points, a step 360 purchases the points and repeats the credit check 350. The redemption voucher generation is explained under the description of FIG.4.

FIGS. 4a and 4b are flow diagrams illustrating redemption voucher generation in package redemption processing 400. Redemption vouchers are used as a form of payment by airlines to book redemption tickets. While in case of non-air redemption the redemption vouchers are used by loyalty members with the loyalty partners who are bound to honor the same in case of availability of the product. The loyalty partners then send the used redemption vouchers to loyalty program operations, for loyalty program to pay the loyalty partners.

In the redemption voucher generation process 400, the redemption request is retrieved from the package redemption processing 300 in a step 402. The loyalty member is asked to confirm the booking in step 404. Once confirmed, a Passenger Name Record (PNR) or record locator is generated in the loyalty program reservation system. If the booking is confirmed, a step 406 performs a credit check and, if the credit check is successful 408, the loyalty member account is debited in another step 412. If the credit check is not successful, the process ends in a step 410. A step 414 checks if the financial entries are enabled. If so, a step 416 initiates financial entry to the general ledger for member account debit and a redemption log is created 418. A step 420 checks if the payment is in monetary currency. If so, a step 422 collects the payment. If payment collection is successful 424, a step 432 initiates financial entry to the accounts receivable (AR) for loyalty member payment. If the payment collection is not successful, a step 426 checks whether to create a service request (SR) and, if so, creates the service request in step 430. If there is no need for a service request, the interaction ends in a step 428.

After initiating financial entries to AR, a step 434 checks for number of products and/or services in the redemption package. A step 436 identifies the redemption voucher type setup and another step 438 generates redemption vouchers. A step 450, checks whether airline redemption is involved and, if so, performs airline product pricing 452. If airline redemption is not involved a step 454 retrieves partner product price list from partner setup and performs partner product pricing 456. A step 458 initiates financial entry to general ledger for redemption voucher liability. After initiating financial entry the process ends with a step 448.

A step 440 checks the outbound communication rules for issuing the redemption vouchers and raises the outbound communication event in another step 442. The outbound communication rules include whom to send (member or partner), form of redemption voucher (document or template) and how to send (the channel of delivery). After checking the outbound communication rules, a step 444 performs the outbound communication process. The redemption vouchers are issued to the corresponding recipient(s) in a step 446. After issuing the redemption voucher(s), the redemption voucher generation process ends in a step 448.

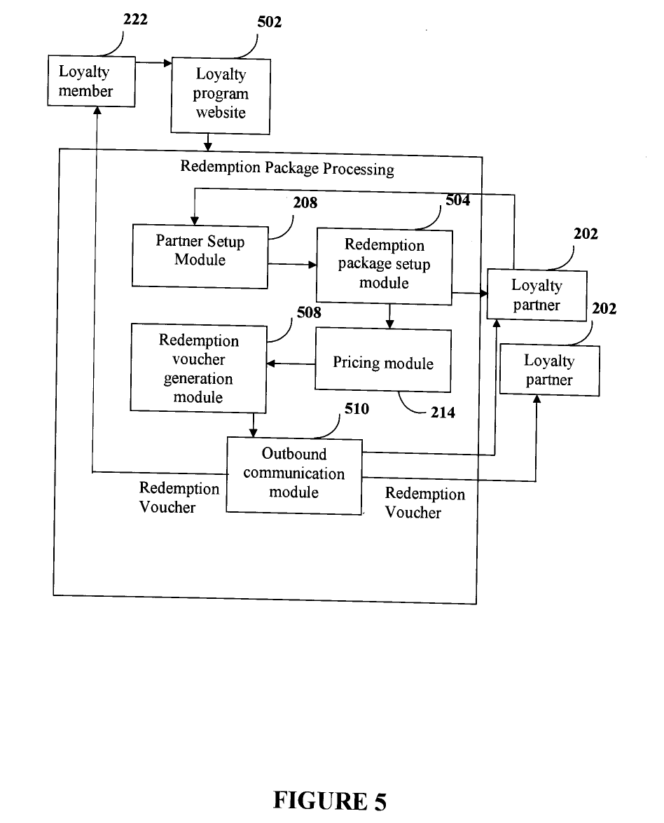

FIG. 5 is a block diagram illustrating the components of a system for package redemption processing. The system includes a partner setup module 208, a redemption package setup module 504, a pricing module 506, a redemption voucher generation module 508 and an outbound communication module 510. A loyalty program website 502 is provided for loyalty members 222 to log in and select the redemption package. The partner setup module 208 is provided for creating a plurality of loyalty partners 202 as an entity, and also, for associating a set of product and/or services offered as package offerings by the loyalty partners 202. The redemption package setup module 504 identifies the redemption packages and sets up a set of contract rules between loyalty partners 202 and loyalty program. After identifying the redemption packages, the pricing module 506 calculates the prices for the set of products and/or services in the redemption packages. After pricing, the redemption voucher generation module 508 generates a set of independent redemption vouchers for the products and/or service in the redemption packages upon receiving the payment from a plurality of loyalty members. The outbound communication module 510, issues the redemption vouchers to the corresponding recipient(s).

The redemption package process including the redemption voucher generation process is explained in the following example. Consider a situation where the loyalty program of Lufthansa Airlines offers to its loyalty members, a packaged offering by which a loyalty member can book two return economy tickets on Lufthansa Airlines flight from Hyderabad to Frankfurt, stay at any Hilton category 1 hotel in Germany for 2 nights and rent a car for 3 days, for 150,000 points from 1^{st} June to 31^{st} July 2006. Loyalty member 222 logs on to a website 502 of a loyalty program to redeem points and select the redemption package for self and spouse. The website checks for products and/or services being offered by which loyalty partner in the redemption package setup module 504. For the flights, the website allows the loyalty member to provide his itinerary, i.e. departure and return flight dates, and retrieves available flights on those dates. Loyalty member 222 selects the itinerary, thereby holding seat inventory. Loyalty member 222 then selects the hotel location, where he wants to stay and the car type which he wants to rent.

Loyalty program website 502 then sends the information of the package selected and the number of travelers to loyalty system. Loyalty system identifies the redemption package and validates the loyalty member and transactional data. This invokes the redemption rules associated to the redemption package setup module 504, and provides quotation of 150,000 (no fees applied as it is not an assisted booking). Loyalty program website 502 publishes the same quotation for loyalty member acceptance. Loyalty system then performs credit check to ascertain sufficient point balance in the loyalty member's account and creates a redemption request if credit check is successful. The loyalty member 222 is requested to confirm booking. Once confirmed, a PNR or record locator is generated in the reservation system. Loyalty member's account is debited by 150,000 points and a redemption log is generated. Financial entry to GL is initiated to account for liability decreasing due to loyalty member account debit. As no monetary payment is involved, the redemption voucher generation module 508 further checks the number of products to issue corresponding redemption vouchers. The redemption voucher generation module 508 then generates the independent vouchers with unique voucher numbers and expiry date as per the voucher type setup.

The outbound communication module 510 checks the outbound communication rules to determine whom to send (member or partner), form of redemption voucher (document template) and how to send (the channel of delivery). The outbound communication module 510 raises an outbound event and initiates outbound process to issue redemption vouchers. In case of airline redemption, the redemption voucher is issued to Lufthansa Airlines, the internal partner, for Lufthansa to issue redemption tickets, while in case of hotel & car rental award, the vouchers are issued to loyalty member 222, for loyalty member 222 to contact the respective loyalty partners 202 to avail the same. The pricing module 506 invokes the partner product pricing rules associated in the partner setup to calculate the monetary price to be paid to each loyalty partners involved in the redemption package.

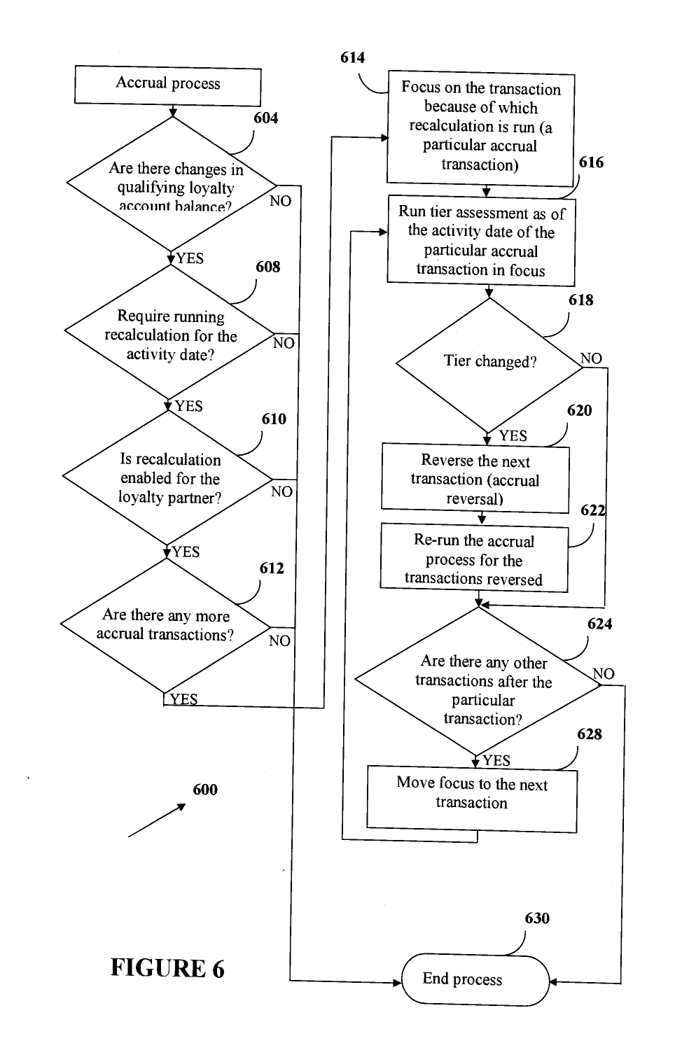

FIG. 6 is a flow diagram illustrating an embodiment of the method for recalculating accruals in loyalty programs 600. The method processes the loyalty member activities received out-of-sequence from the loyalty partners, as of the date they were undertaken (as against when they were received). Then it follows up the same with re-assessment of loyalty member's status (tiers) as of that activity date (loyalty member's status may undergo change with this new accrual resulting out of the processing of out-of-sequence activity). It also recalculates the accruals for all the loyalty member activities, which were processed earlier but occurred later than the activity, which is received out-of-sequence. This process ensures that the loyalty members get exactly what is due to them and takes care of partner billing reversal and recalculation and also initiates adjustments in financial entries to effect the change in loyalty units' liability.

In the accrual recalculation process 600, a step 604 identifies if the transaction changes the qualifying loyalty account balance of the member. A step 608 decides if recalculation for the activity date is enabled for the loyalty program. If recalculation is enabled, a step 610 checks if the accrual recalculation is enabled for the loyalty partners. A step 612 checks if any more accrual transactions occurred after the transaction due to which accrual recalculation is being performed (current transaction). The accrual recalculation process 600 focuses on the current transaction in step 614. A tier assessment as of the activity date of the current accrual transaction is performed in a step 616.

A step 618 determines if there is a tier change in Step 616, and if the tier change has occured, the next accrual activity is reversed in the chronological order (according to the sequence of occurrence) in a step 620. A step 622 reprocesses the reversed accrual transaction, then again performs the tier assessment to see if there is any tier change as of the activity date of the re-processed accrual. A step 624 checks if there are any more accrual transactions occurred after the reversed accrual activity. If so, a step 628 proceeds to the next accrual transaction and performs steps 614-624 for the next accrual transaction. In the similar way accruals are reversed and re-processed till the last accrual activity. After accrual recalculation process is performed for all the remaining accrual transactions, the process ends in a step 630.

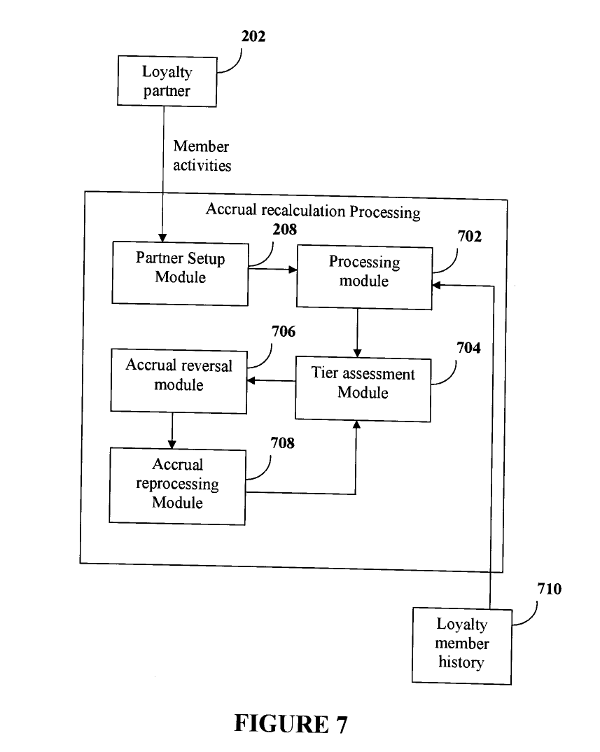

FIG. 7 is a block diagram illustrating the components of an accrual recalculation engine according to an embodiment of the present invention. The accrual recalculation engine includes a partner setup module 208, a processing module 702, a tier assessment module 704, an accrual reversal module 706 and an accrual reprocessing module 708. The partner setup module 208 is provided for creating loyalty partners 202 as an entity and also for receiving loyalty member activities from the loyalty partners 202 associated with the loyalty program. The processing module 702 checks if recalculation of accruals is required. Accrual recalculation is required if there is a change in qualifying loyalty account balance in the loyalty member account, if one or more accrual activities occurred after the current accrual activity and if a loyalty member has undergone a tier change after the current activity date. The processing module 702 processes the loyalty member activities according to a date of the activities in a chronological order of occurrence based on Loyalty Member History 710. The tier assessment module 704 performs a tier assessment for the loyalty member activities according to the date of activities focusing on a current accrual transaction for which accrual recalculation is required. If the tier change is detected, the accrual reversal module reverses the next accrual activities in the chronological order (according to the sequence of occurrence). The accrual reprocessing module 708 reprocesses the reversed accrual activities and the tier assessment module 704 performs a tier assessment to check to see if there is a tier change as of the reversed accrual activity.

Foregoing described embodiments of the invention are provided as illustrations and descriptions. They are not intended to limit the invention to precise form described. Other variations and embodiments are possible in light of above teachings, and it is thus intended that the scope of invention not be limited by this detailed description, but rather by claims following.

1. A method for processing accrual package offerings in a loyalty program comprising the steps of:
identifying a set of said accrual package offerings in a loyalty program system, the package offerings comprising constituent products and/or services offered by a plurality of loyalty partners;
identifying a plurality of loyalty members satisfying a set of accrual package conditions for availing the package bonus;
calculating accrual bonus for each of said plurality of loyalty members for the package offerings and crediting the loyalty members with loyalty units; and
identifying said loyalty partners for the package offerings and debiting loyalty partner accounts.

2. The method of claim 1, further comprising:
initiating a financial entry for liability to a general ledger for said member account credits and loyalty partner account debits.

3. The method of claim 1, further comprising:
updating a package accrual information and creating a package transaction history in said loyalty program system.

4. The method of claim 1, wherein the package offerings comprise a package of two or more products and/or services offered by loyalty partners to the loyalty members for a fixed period of time.

5. A method for processing redemption package offerings in a loyalty program, said package offerings comprising a set of redemption packages offered by a set of loyalty partners, said method comprising the steps of:
receiving a redemption request for availing one or more of said set of redemption packages form a set of loyalty members associated with said loyalty program;
identifying the redemption packages and validating said redemption request;
pricing a set of products and/or services in the redemption packages; and
generating a set of independent redemption vouchers for the products and/or service in the redemption packages upon receiving the payment from the loyalty members and issuing said set of redemption vouchers to the corresponding loyalty partners.

6. The method of claim 5, wherein said validating the redemption request comprises validating a loyalty member data and transactional data.

7. The method of claim 5, wherein said generating a set of independent redemption vouchers further comprises:
receiving said payment from the loyalty members and initiating a financial entry to a general ledger in the loyalty program system;
checking a number of products and/or services in the redemption packages for issuing corresponding redemption vouchers;
identifying a redemption voucher type setup and generating redemption vouchers; and
checking a set of outbound communication rules for identifying a channel of delivery, a form of redemption voucher and recipient(s) for issuing the redemption vouchers.

8. The method of claim 7, wherein said recipient(s) include loyalty partners and loyalty members.

9. A system for processing accrual package offerings in a loyalty program comprising of:
a partner setup module for creating a plurality of loyalty partners as an entity and associating a set of product and/or services offered by said loyalty partners;
an accrual package setup module for identifying a set of said package offerings in a loyalty program system, the package offerings comprising constituent products offered by the loyalty partners;
an accrual rules setup module for identifying a plurality of loyalty members satisfying a set of package conditions and for identifying the loyalty partners for the package offerings;
a pricing module for calculating accruals for each of said plurality of loyalty members for the package offerings and crediting the loyalty members with loyalty units; and
a partner account debit module for debiting each loyalty partner accounts.

10. The system as in claim 9, further comprising:
a transaction module for initiating a financial entry for liability to a general ledger for said member account credits and loyalty partner account debit; and
a transaction history module for updating a package accrual information and creating a package transaction history in said loyalty program system.

11. A system for processing redemption package offerings in a loyalty program, said package offerings comprising a set of redemption packages offered by a set of loyalty partners, said system comprising of:
a partner setup module for creating a plurality of loyalty partners as an entity and associating a set of product and/or services offered by said loyalty partners;
a redemption package setup module for identifying the redemption packages and setting up a set of contract rules between loyalty partners and loyalty program;
a pricing module for pricing a set of products and/or services in the redemption packages; and
a redemption voucher generation module for generating a set of independent redemption vouchers for the products and/or service in the redemption packages upon receiving the payment from a plurality of loyalty members and for issuing said set of redemption vouchers to the corresponding loyalty partners.

12. The system as in claim 11, further comprising:
an outbound communication module for issuing the set of redemption vouchers to the recipient(s).

13. The system as in claim 12, wherein said issuing the redemption vouchers include checking a set of outbound communication rules for identifying a channel of delivery, a form of redemption voucher and recipient(s) for issuing the redemption vouchers.

14. A method for recalculating accruals in a loyalty program comprising the steps of:
receiving a set of loyalty member activities from a plurality of loyalty partners;
processing said loyalty member activities in a sequential manner according to a date of the activities;
checking a necessity for recalculating said accruals; and
recalculating the accruals for said loyalty member activities.

15. The method of claim 14, wherein said checking comprises:
verifying a change in a qualifying loyalty account balance in loyalty member accounts;
identifying a current accrual transaction for which accrual recalculation is required; and
verifying whether one or more loyalty member activities occurred after said current accrual transaction.

16. The method of claim 14, wherein said recalculating the accruals comprises:
performing a tier assessment according to the date of activity focusing on the current accrual transaction;
performing an accrual reversal for accrual activities following the current accrual transaction in a chronological order; and
reprocessing the accrual activities reversed in the reversal step and performing tier assessment according to the reprocessed accrual activities.

17. An accrual recalculation engine in a loyalty program comprising:
a partner setup module for creating a plurality of loyalty partners as an entity and for receiving a set of loyalty member activities from said plurality of loyalty partners associated with said loyalty program;
a processing module for checking a necessity for recalculating said accruals and for processing said loyalty member activities according to a date of the activities;
a tier assessment module for performing a tier assessment for said loyalty member activities according to the date of activities focusing on a current accrual transaction for which accrual recalculation is required;
an accrual reversal module for performing an accrual reversal for accrual activities following said current accrual transaction in a chronological order; and
an accrual reprocessing module for reprocessing the accrual activities reversed in said accrual reversal module and performing tier assessment according to the reprocessed accrual activities.
